(19) United States
(12) Patent Application Publication
(10) Pub. No.: US 2005/0264236 A1
(43) Pub. Date: Dec. 1, 2005

(54) Apparatus and method for use in triggering a flash lamp

(75) Inventors: Samuel W. Lloyd, La Mesa, CA (US); Eddie Lee Brown, Alpharetta, GA (US)

Correspondence Address: FITCH EVEN TABIN AND FLANNERY, 120 SOUTH LA SALLE STREET, SUITE 1600, CHICAGO, IL, 60603-3406, US

(73) Assignee: PurePulse Technologies, Inc, San Diego, CA (US)

(21) Appl. No.: 10/854,444

(22) Filed: May 25, 2004

(51) Int. Cl. H05B 37/00

(52) U.S. Cl. 315/200 A

(57) ABSTRACT

An apparatus, system and method are provided for use in triggering a flash lamp and treating fluids. In some embodiments, a flash lamp assembly is provided that includes a chamber that surrounds a flash lamp with first and second electrodes that extend through the chamber, and a trigger element positioned adjacent an exterior of the chamber. First and second ends of the trigger element can, in some implementations be proximate the first and second electrodes. Some embodiments provide a fluid treatment system that includes a flash lamp enclosed within a chamber, and a trigger element positioned adjacent an exterior of the chamber. The chamber include an inlet and outlet where fluid to be treated is pushed into the chamber to pass about the flash lamp without contacting the trigger element.

### FIELD OF THE INVENTION

The present invention relates generally to triggering flash lamps, and more particularly to externally triggering a flash lamp while passing fluid around the flash lamp.

### BACKGROUND OF THE INVENTION

Previous flash lamps have many commercial, military, industrial, academic, medical, environmental, agricultural and other uses. However, previous flash lamps have limited configurations. These limited configurations further limit the application and implementation of flash lamps.

Typical flash lamps utilize a trigger winding that is directly wound around the flash lamp. This winding is used to generate an adequate electric field within the flash lamp to trigger the lamp to emit light. The winding is positioned wound around the flash lamp and often in contact with the lamp.

Alternate configurations are needed to enhance the use of flash lamps and allow for alternate implementations. Further, alternate configurations are needed to reduce the cost of manufacturing and operating flash lamps.

### SUMMARY OF THE INVENTION

The present invention advantageously addresses the needs above as well as other needs through the provision of the methods and apparatuses for use in triggering a flash lamp. In some embodiments, a flash lamp assembly is provided that includes a flash lamp having a first electrode and a second electrode; a chamber that surrounds the flash lamp, wherein the first and second electrodes extend through and out of the chamber; and a trigger element is positioned proximate an exterior of the chamber extending over a portion of the exterior of the chamber. In some implementations, the trigger element has a first end and a second end, and the trigger element is positioned proximate the chamber such that the first end of the trigger element is proximate the first electrode and the second end of the trigger element is proximate the second electrode. Further, the trigger element can, in some embodiments extend generally parallel along a length of the chamber. In some embodiments, a fluid is passed through the chamber without contacting the trigger element and is treated by light emitted by the flash lamp.

Some embodiments provide a system for treating fluid. A fluid treatment system can include a chamber; a flash lamp that has a first electrode and a second electrode, wherein the flash lamp is enclosed within the chamber; and a trigger element is positioned adjacent an exterior of the chamber and extending along at least a portion of a length of the chamber; wherein the chamber further comprising an inlet and an outlet, such that a fluid to be treated is pushed into the chamber through the inlet and out of the chamber through the outlet to pass about the flash lamp to be treated. The fluid passes through the chamber without contacting the trigger element. In some embodiments, a first end of the trigger element is proximate the first electrode and a second end of the trigger element is proximate the second electrode. The fluid treatment system can further include a fluid reservoir containing the fluid coupled with the chamber; and a fluid pump coupled with the fluid reservoir, wherein the fluid pump pumps fluid through the chamber and about the flash lamp.

Additional embodiments provide for a method of treating a fluid. The method can include flowing a fluid to be treated into a chamber such that the fluid circulates about a flash lamp that is housed within the chamber; exciting the flash lamp; and triggering the flash lamp through a trigger that is external to the chamber such that the flash lamp flashes treating the fluid. The flowing of the fluid further comprises maintaining a portion of the fluid within the chamber for a predefined period of time circulating about the flash lamp; and the triggering further comprises triggering the trigger a plurality of times such that the flash lamp flashed a predefined number of times during the predefined period of time. In some embodiments, the method further comprises estimating a particular velocity of the fluid flowing through the chamber; and setting a flash rate of the flash lamp based on the particular velocity in order to optimize light treatment of the fluid.

Additional embodiments provide a method for use in triggering a flash lamp system. The method comprises applying a trigger pulse to a trigger electrode structure located external to an enclosure, where a flash lamp is located substantially inside the enclosure, and pulsing the flash lamp following the applying of the trigger pulse. The can further comprise pushing a fluid through the enclosure such that the fluid passes about the flash lamp as the trigger pulse is applied such that the fluid does not contact the trigger electrode.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a typical flash lamp;

FIG. 2 depicts a simplified cross-sectional, block diagram of a flash lamp assembly according to some present embodiments;

FIG. 3 depicts a simplified prospective view of the flash lamp assembly of FIG. 2;

FIG. 4 depicts a simplified cross-sectional diagram of a flash lamp assembly similar to FIG. 2;

FIG. 5 depicts a simplified block diagram of a fluid treatment system according to some embodiments;

FIG. 6 shows a simplified cross-sectional diagram of a flash lamp assembly according to some embodiments;

FIG. 7 depicts a simplified perspective view of a flash lamp assembly;

FIG. 8 depicts a simplified schematic diagram of the fluid treatment system according to some embodiments;

FIG. 9 depicts a simplified schematic diagram of a flash lamp assembly according to some embodiments that can be incorporated into fluid treatment systems, such as the fluid treatment system shown in FIG. 8;

FIG. 10 depicts a simplified cross-sectional view along an axis labeled in FIG. 6 of a flash lamp assembly;

FIG. 11 depicts a flowchart of a process for use in setting the flash rate of a flash lamp in a fluid treatment system, such as the fluid treatment system of FIG. 5;

FIG. 12 is a simplified cross-sectional view of a flash lamp assembly according to some present embodiments; and

FIG. 13 depicts a simplified cross-sectional view of the flash lamp assembly of FIG. 12 viewed from an axis defined in FIG. 12.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

The present embodiments provide for a method and apparatus for triggering a flash lamp. Further, the present embodiments provide a method and apparatus for use in treating products, including liquid products. Still further, the present embodiments provide flash lamp assemblies that employ beneficial and novel triggering. The triggering is achieved with smaller and less expensive transformers. The present embodiments further provide triggering without having triggering wire in contact with products to be treated.

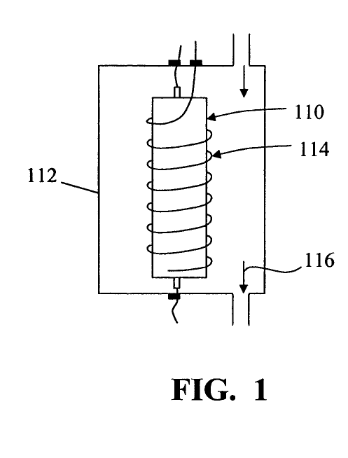

FIG. 1 depicts a simplified block diagram of a typical flash lamp 110. A trigger wire winding 114 is directly wrapped around the flash lamp 110. In operation, a high voltage triggering pulse is applied to the winding 114 producing an intense electric field. This electric field causes the ionization of the gaseous medium in the lamp. Electrodes 120 further couple with the lamp 110 to provide supply current to the lamp following the ionization to provide voltage pumping of the lamp.

The wire winding 114 requires a third electrical connection to penetrate the enclosure 112, which may be quite large and costly since trigger wire 114 is pulsed with a high voltage. Additionally, in some implementations, this flash lamp and triggering are incorporated into a fluid treatment system with the flash lamp and trigger housed in an enclosure or chamber 112 where fluid 116 is passes into the chamber and around the flash lamp, in contact with the flash lamp 110 and the trigger wire winding 114. As a result, the fluid to be treated is directly in contact with the trigger wire when voltage is applied to the wire winding, which can result in adverse affects on the fluid or adverse safety implications for system design.

Some flash lamps employ series injection triggering. The lamps use a trigger transformer that is incorporated into a main discharge circuit. A high voltage pulse is typically applied to one of the main flash lamp electrodes. In this case the trigger transformer typically must carry the main lamp discharge current, and so the transformer is large and expensive. These series injection triggering lamps, however, only have two connections to the lamp, and thus an external wire is not generally needed.

Some flash lamps employ external triggering. Externally triggered lamps typically apply a high voltage pulse to a wire external to the lamp. In this scheme, basically an open circuit is being driven, the pulse energy is low, and the trigger transformer can typically be small. These externally triggered lamps, however, typically require three lamp connections (two for the main electrodes and one for the trigger wire). As a result, the external trigger wire would be directly exposed to a product in some treatment processes, which could have significant adverse side effects and/or prevent such lamps from being employed.

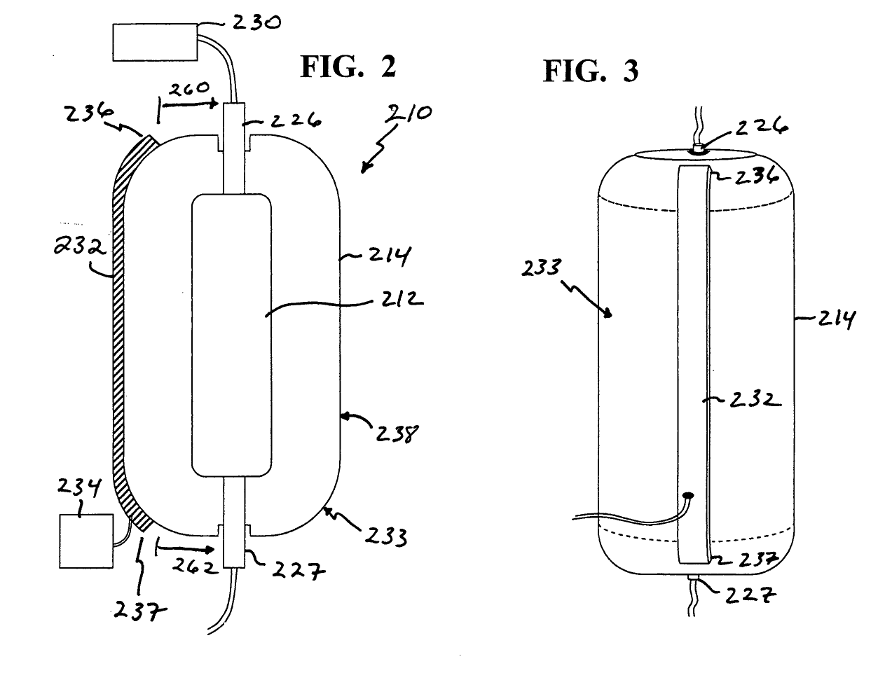

FIG. 2 depicts a simplified cross-sectional, block diagram of a flash lamp assembly 210 according to some present embodiments. FIG. 3 depicts a simplified prospective view of the flash lamp assembly 210 of FIG. 2. Referring to FIGS. 2 and 3, the flash lamp assembly 210 includes a flash lamp 212 housed in a chamber or housing 214. The flash lamp can be a Xenon or Krypton gas filled flash lamp, or other similar lamps. In some embodiments, the flash lamp can additionally include one or more dopants for microwave assisted flash lamp, such as those described in U.S. Pat. No. 6,087,783 of Eastland, et al., entitled METHOD AND APPARATUS UTLILIZING MICROWAVES TO ENHANCE ELECTRODE ARC LAMP EMISSION SPECTRA, issued Jul. 11, 2000, which is incorporated herein by reference.

One or more trigger elements 232 are positioned along at least a portion of an exterior 233 of the chamber 214. The trigger element(s) can be an exposed portion of wire, a strip or plate of conductive metal, a plurality of wires or plurality of strips of metal, a mesh structure and other similar configurations positioned along the exterior of the chamber 214. For example, the trigger element can be a strip of one inch wide conductive tape extending along the exterior of the chamber 214. As another example, the trigger element can be one or more wires (e.g., 18 AWG wiring) extending along the exterior of the chamber with ends proximate the electrodes. Typically, the wiring is positioned closer to the electrodes than the one inch wide conductive tape. In some embodiments, a plurality of trigger elements 232 are positioned about the exterior of the chamber 214, for example, two strips can be place on opposite sides of the chamber, four strips can be placed 90 degrees apart around a chamber with a circular cross-section (or on each side of a square or rectangular cross-sectional chamber), and other such configurations. The trigger element 232 couples with a pulse or trigger source 234. The trigger source supplies a trigger voltage to the trigger element 232 that is sufficient to trigger the flash lamp 212 and ionize the gas and/or gases of the flash lamp.

The flash lamp 212 further includes two electrodes 226, 227. The lamp electrodes 226, 227 extend through the chamber 214 to couple with the flash lamp 212. An excitation system or pump circuit 230 couples with at least the first electrode 226 to provide an excitation voltage to the flash lamp. Once gas(es) is ionized by the trigger element 232, the excitation circuit supplies an excitation voltage to the electrodes to cause optimal excitation of the lamp and thus the illumination of the lamp.

In some embodiment, the trigger element 232 is positioned adjacent the exterior of the chamber. The trigger element is further configured so that ends 236, 237 of the trigger element are proximate the flash lamp electrodes 226, 227. The distances 260, 262 between the trigger element ends 236, 237 and the electrodes 226, 227 can vary depending on the voltage applied to the trigger element and the width 274 (see FIG. 7) of the trigger element. Similarly, the width of the trigger element 232 can vary depending on the distance between the trigger element and the lamp electrodes and the voltage applied to the trigger element. The size of the flash lamp 212 and the distance between the flash lamp and the chamber walls 238 can also be taken into consideration in determining a length and width of the trigger element 232. Other factors that can be taken into consideration are the coolant utilized, the material used to manufacture the chamber and other similar factors.

The trigger element ends 236 and 237 are positioned to trigger the flash lamp and ionize the gas(es) within the lamp. The distances between the trigger ends 236, 237 and the electrodes 226, 227 can vary as discussed above. For example, a first trigger end 236 can be positioned about 5 mm from the first electrode 226, which can be an anode of the flash lamp, and the second trigger end 237 can be positioned about 20 mm from the second electrode 227, which can be a cathode of the flash lamp. As another example, the first trigger end 236 can be positioned about 50 mm from the anode and the second trigger end 237 can be positioned about 50 mm from the cathode. Again, the precise positioning is dependent on the size of the trigger element 232 and the trigger voltage applied to the trigger element.

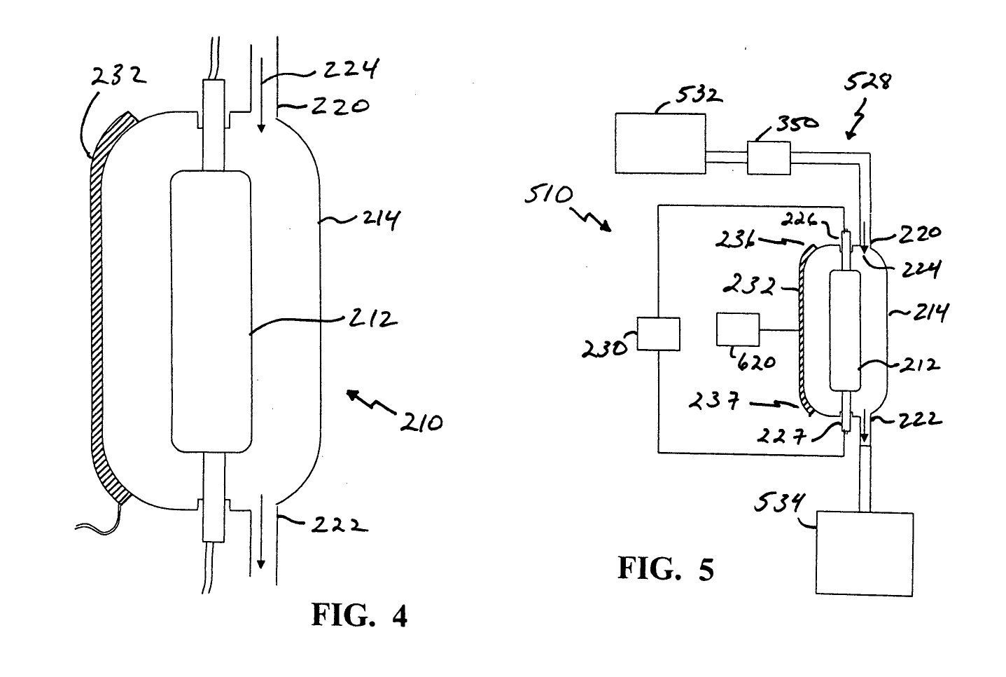

FIG. 4 depicts a simplified cross-sectional diagram of a flash lamp assembly 210 similar to FIG. 2, according to some embodiments. In these embodiments, the chamber further includes a fluid inlet 220 and outlet 222. The inlet and outlet couple with a fluid pump system 528 (see FIG. 5) that pumps fluid through the chamber 214. The pump system can be substantially any relevant pump system and/or other system or process for moving fluid through the chamber, such as connection to a pressurized water system (such as a municipal tap or an reverse osmosis (RO) system pressure tank) or other means of causing fluid to move through the chamber. The fluid 224 is passed into the chamber through the inlet 220, and exits through the outlet 222. The flow of fluid through the chamber circulates around the flash lamp 212. Fluid products may be continuously pumped through the chamber 214 or periodically pumped into and out of the chamber so that a portion of fluid is static while treated within the chamber such that the flash lamp is triggered one or more times. In some alternative embodiments, the fluid circulated through the chamber 214 and around the flash lamp 212 is not a fluid to be treated but in stead is a coolant to maintain a temperature of the flash lamp. Further, some fluids aid in coupling the trigger energy to the flash lamp.

The trigger element 232 is preferably positioned on the exterior of the chamber 214 such that the trigger element does not contact the fluid 224. In some embodiments, the flash lamp can additionally be surrounded by a protection layer or tube (not shown) that prevents the fluid from directly contacting the flash lamp. Further, the protection layer can provide filtering of light generated from the flash lamp if desired. The protection layer is transparent to at least one wavelength emitted by the flash lamp.

FIG. 5 depicts a simplified block diagram of a fluid treatment system 510 according to some embodiments. The system 510 includes a flash lamp assembly 210 with a flash lamp 212 housed in a chamber 214. The chamber has an inlet 220 and an outlet 222 coupled with a system 528 for moving fluid through the chamber, such as a fluid pump system. The fluid pump system has a reservoir 532 of fluid (where the fluid can include liquid(s) and/or gas(es)) to be treated, a fluid pump 530 to pump the fluid from the reservoir 532 to the chamber 214, and a receiving tank 534. In some embodiments, the receiving tank is replaced by a plurality of receiving devices, such as bottles, containers and other similar storage devices for receiving and storing treated fluid.

The fluid treatment system 510 further includes an excitation system 230 coupled with the electrodes 226 and 227 of the flash lamp 212. A trigger element 232 is positioned exterior to the chamber 214. In some embodiments, the trigger element 232 is secured with the chamber, in other embodiments the trigger element is positioned proximate the chamber wall 238. For example, the trigger element can be a 1/2 inch wide strip of conductive material (e.g., copper). The ends 236, 237 of the trigger element 232 are positioned proximate the electrodes 226, 227. A triggering network 620 couples with the trigger element to supply a trigger voltage to the trigger element.

Fluid is pumped through the chamber 214 by the fluid pump 530 while the triggering network 620 and excitation system or circuit 230 activate and pulse the flash lamp 212. The illumination of the flash lamp treats the fluid or gas as it passes through the chamber 214 and around the flash lamp 212. The flash lamp is activated according to defined parameters to achieve a desired treatment of the fluid. For example, the flash lamp is activated at a predefined flash rate to better optimize the treatment of the fluid. The flash rate is typically dependent on the fluid flow rate as described fully below. Because the trigger element 232 is positioned on the exterior of the chamber 214, the trigger element is not in contact with the fluid to be treated. This avoids some of the problems seen in previous systems where fluid contact with the trigger wire winding can damage or adversely affect the fluid.

As discussed above, the fluid being passed through the chamber 214 can be a fluid to be treated by the flash lamp, such as pasteurizing, sterilizing, prolonging shelf life, altering, deactivating, or activating portions of the fluid product. For example, in several embodiments, the light treatment is intended to inhibit or deactivate microorganisms within the product or otherwise cause a photochemical reaction in the product, where the term “microorganism” is used generically and meant to include viruses, fungus, bacteria, contaminants and other living and non-living microorganisms that may be pathogenic or non-pathogenic. It is noted that the term “a” appearing throughout is intended to mean “one or more” unless otherwise stated, i.e., the term “a” covers the singular and plural.

The fluid products to be treated can include substantially any fluid and/or gas product for treatment, including, but not limited to, water, biological fluids and their derivatives (such as, blood, blood plasma, blood plasma derivatives), bioprocessing fluids, drugs and pharmaceuticals, especially bio-pharmaceuticals (such as monoclonal antibodies), solutions such as a buffer, glucose and other sugar solutions, culture medias, as well as molecular biology and biochemistry reagents, air, oxygen and other similar products. Such products may be naturally occurring or synthetically produced.

The term “light treatment” refers to any type of light treatment, such as continuous wave light treatment or pulsed light treatment. Furthermore, the light treatment may include light having one or more wavelengths. Additionally, depending on the embodiment, the light treatment is used generally for the purpose of “treating” the product. For example, the light treatment is for the purpose of modifying or altering the product, or otherwise stimulating a change in the product. For example, in several embodiments, the light treatment is intended to inhibit or deactivate microorganisms within the product or otherwise cause a photochemical reaction in the product.

According to some embodiments, the flash lamp assembly 210 provides pulsed polychromatic light, for example, broad spectrum pulsed light (BSPL). The BSPL is produced by flash lamp 212, such as a Xenon gas flash lamp. BSPL is pulsed light in the form of high-intensity, short duration pulses of incoherent polychromatic light in a broad spectrum, also referred to as broad-spectrum pulsed light (i.e. BSPL) or broadband pulsed light.

The light generated from the flash lamp assembly 210 for example, broad spectrum pulsed light (BSPL), illuminates and treats the fluid passing through the chamber 214 and around the flash lamp 212. In some implementations, a portion of the fluid is illuminated by at least one, preferably at least two and more preferably at least three (e.g., 3, 5, 10, 15, 20, 30, 40 or more) consecutive short duration (e.g., less than about 100 ms, such as about 150 μs or 300 μs) pulses of high-intensity (e.g., 0.001 J/cm² to 50 J/cm², e.g., 0.01 J/cm² to 1.0 J/cm², depending on the type of fluid being treated) incoherent polychromatic light in a broad spectrum (e.g., 170 nm to 2600 nm; i.e., 1.8×10¹⁵ Hz to 1.2×10¹⁴ Hz).

Such polychromatic light, however, may comprise wavelengths within any subset of the range of 170 nm to 2600 nm (by filtering the emitted light, for example), e.g., the energy density or fluence of the pulsed light may be concentrated within wavelengths between 170 nm and 1800 nm, between 170 nm and 1000 nm, between 200 nm and 500 nm, or between 200 nm and 300 nm, for example. Furthermore, it has been found that certain biological fluids are most effectively treated with many short duration pulses of polychromatic light at relatively lower fluence levels. For example, in such cases, the fluid product is illuminated with about 20, 30 or 40 or more short duration pulses having intensities between 0.001 and 0.1 J/cm².

Broad-spectrum pulsed light (BSPL) described through this specification as a light treatment may also be referred to generically as “pulsed polychromatic light” or even more generically as pulsed light. Pulsed polychromatic light represents pulsed light radiation over multiple wavelengths. For example, the polychromatic light, whether pulsed or continuous wave, may comprise light having wavelengths between 170 nm and 2600 nm inclusive, such as between 180 nm and 1500 nm, between 180 nm and 1100 nm, between 180 nm and 300 nm, between 200 and 300 nm, between 240 and 280 nm, or between any specific wavelength range within the range of 170-2600 nm, inclusive. A choice of materials and/or spectral filters can be employed to produce a desired spectral range of the illumination. As is generally known, Xenon gas flash lamps produce pulsed polychromatic light having wavelengths at least from the far ultraviolet (200-300 nm), through the near ultraviolet (300-380 nm) and visible (380 nm-780 nm), to the infrared (780-1100 nm). In one example, the pulsed polychromatic light produced by these Xenon gas flash lamps is such that approximately 25% of the energy distribution is ultraviolet (UV), approximately 45% of the energy distribution is visible, and approximately 30% of the energy distribution is infrared (IR) and beyond. It is noted that the fluence or energy density at wavelengths below 200 nm is negligible, e.g., less than 1% of the total energy density. Furthermore, these percentages of energy distribution may further be adjusted. In other words, the spectral range may be shifted (e.g., by altering the voltage across the flash lamp) so that more or less energy distribution is within a certain spectral range, such as V, visible and IR. In some embodiments it may be preferable to have a higher energy distribution in the UV range. It is further noted that pulsed polychromatic light may be produced by light sources other than Xenon gas flash lamps.

Although many embodiments of the invention utilize a light source 212 that provides a light treatment including pulsed polychromatic light (one example of which being BSPL), other embodiments of the invention use a light source that provides pulses of monochromatic light, such as a pulsed laser emitting light at a specified wavelength. Thus, when referring to a fluid treatment system that uses “pulsed light”, it is meant that this pulsed light may be polychromatic or monochromatic pulsed light. It is also noted that although preferred embodiments of the invention utilize pulsed light, some embodiments utilize a light source that provides continuous wave light, such as a continuous wave UV light, such as provided by Mercury gas lamps.

Thus, in general terms, the light source of the fluid treatment system comprises a light source emitting light having at least one wavelength of light within a range between 170 nm and 2600 nm. For example, a pulsed polychromatic flash lamp (broad spectrum or narrow spectrum), a pulsed UV lamp, a pulsed laser, a continuous wave lamp, a continuous wave UV lamp, etc., could all serve as a light source that may be used according to different embodiments of the invention.

Furthermore, in some embodiments, at least 0.5% (preferably at least 1% or at least 5%) of the energy density or fluence level of the pulsed polychromatic (or monochromatic) light emitted from the flash lamp is concentrated at wavelengths within a range of 200 nm to 320 nm. The duration of the pulses of the pulsed light should be approximately from about 0.01 ms to about 100 ms, for example, about 10 μs to 300 μs.

In some embodiments, the fluence or intensity of the pulsed light should be from 0.001 J/cm² to 50 J/cm², e.g., 1.0 J/cm² to 2.0 J/cm², depending on the fluid being treated. In embodiments where the fluid product to be treated is a blood plasma derivative or other bioprocessing fluid, the fluence of the pulsed light should be carefully selected to avoid extensive protein damage while at the same time deactivate microorganisms to a specified log reduction.

For example, when treating biological fluids and their derivatives, such as blood, blood plasma, and blood plasma derivatives, the fluid product is illuminated with pulses of light having a fluence level preferably between 0.1 and 0.6 J/cm². As a result of such illumination, microorganisms, such as viruses, fungus, bacteria, pathogens and other contaminants contained within the fluid are effectively deactivated up to a level of 6 to 7 logs reduction or more (i.e., a microbial reduction level that is commonly accepted as sterilization).

In many applications, biological fluids are treated primarily to deactivate microorganisms without causing excessive protein damage. Thus, in these embodiments, the pulsed light treatment is configured to provide greater than 2 logs reduction, more preferably greater than 4 logs reduction and most preferably greater than 6 logs reduction is achieved with minimum protein damage. Although some of these deactivation levels fall short of what is accepted as sterilization, the pulsed light provides a significant advantage over a continuous wave UV treatment system in that microorganisms and other contaminants are effectively deactivated at desired log reduction rates with minimum protein damage in a short period of time. Furthermore, the use of BSPL using Xenon flash lamps completely eliminates the problem of Mercury contamination due to broken Mercury lamps that may be encountered in such a continuous wave UV fluid treatment device, since Xenon is an inert gas which is harmless if exposed due to leakage or breaking of the Xenon flash lamp. Variants of Xenon flash lamps, such as those described in U.S. Pat. No. 6,087,783 of Eastland, et al., entitled METHOD AND APPARATUS UTLILIZING MICROWAVES TO ENHANCE ELECTRODE ARC LAMP EMISSION SPECTRA, issued Jul. 11, 2000, which is incorporated herein by reference, may also be used as an appropriate light source for the fluid treatment system.

As indicated above, in some alternative embodiments, the fluid circulated through the chamber 214 and around the flash lamp 212 is not a fluid to be treated but instead is a coolant to maintain a temperature of the flash lamp. The coolant can be water, air or other fluids or gases capable of cooling the flash lamp. In these embodiments, the chamber 214 is constructed of substantially any material that is translucent to at least a desired wavelength or range of wavelengths of the illumination generated from the flash lamp 212. For example, the chamber can be constructed of a clear plastic, glass, quartz and other similar material. Typically, the chamber is constructed of a non-metallic and/or non-conductive material. A product can be positioned near the flash lamp assembly 210 to be treated. The product to be treated can be a solid or a fluid (e.g., liquid or gas) product. A solid can be positioned near or adjacent the flash lamp assembly or passed by the flash lamp assembly, for example, transported on a conveyer. Similarly, the fluid can be pumped through a treatment chamber, structure or tubing positioned adjacent the chamber 214. For example, the flash lamp assembly can be employed in the fluid treatment system described and shown in U.S. patent application Ser. No. 10/150,345, of Brown et al., entitled LIGHT TREATMENT CONTROL IN A FLUID TREATMENT SYSTEM USING LIGHT FOR THE TREATMENT OF FLUID PRODUCTS, filed May 17, 2002, Docket No. 72722, incorporated herein by reference in its entirety; U.S. patent application Ser. No. 09/976,597, of Fries et al., entitled SYSTEM FOR THE DECONTAMINATION OF FLUID PRODUCTS USING LIGHT, filed Oct. 12, 2001, Docket No. 70683, incorporated herein by reference in its entirety; and U.S. patent application Ser. No. 09/976,776, of Fries et al., entitled FLUID FLOW PATH FOR A FLUID TREATMENT SYSTEM USING LIGHT FOR THE DECONTAMINATION OF FLUID PRODUCTS, filed, Oct. 12, 2002, Docket No. 71715, incorporated herein by reference in its entirety.

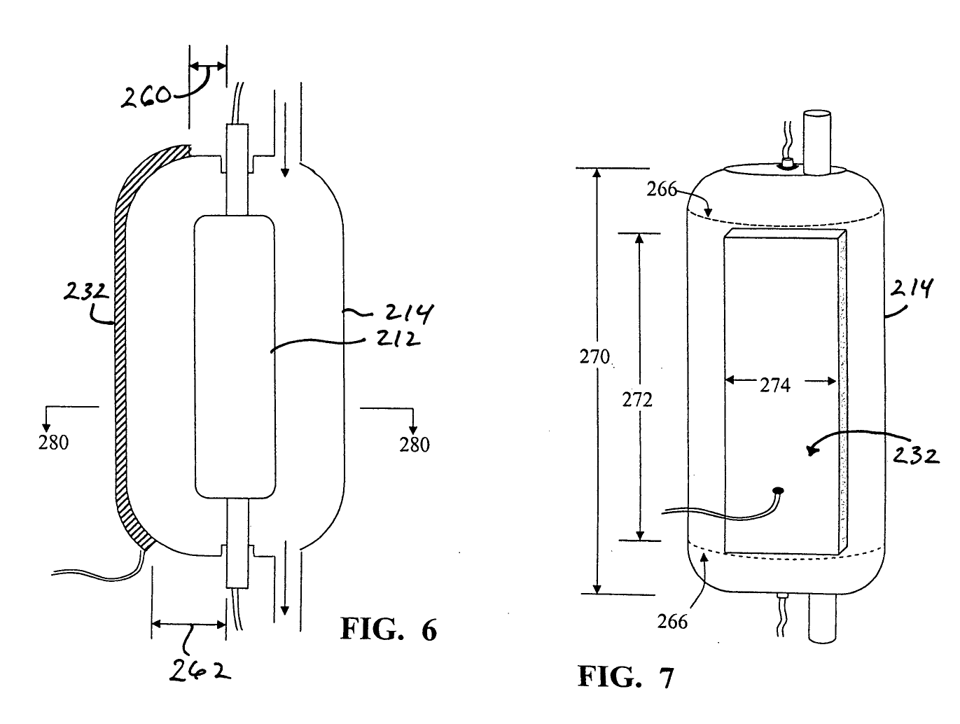

FIG. 6 shows a simplified cross-sectional diagram of a flash lamp assembly 210 according to some embodiments. The trigger element 232 is configured such that the first trigger end 236 is positions a first distance 260 that is relatively close to the anode 226 of the flash lamp 212. For example, the first end is positioned 4 mm from the anode. The second trigger end 237 is positioned a second distance 262 that is close to the cathode 237 of the flash lamp 212, but at a greater distance than the first distance 260. For example, the second trigger end 237 is positioned a distance 262 that is approximately 25 mm from the cathode 227.

FIG. 7 depicts a simplified perspective view of a flash lamp assembly 210 according to some embodiments. The trigger element 232 is configured to extend along a length 270 of the chamber, generally parallel with the length. Further, the length 272 of the trigger element is such that the first end 236 and the second end 237 do not pass baffles 266 of the chamber 214. Further, the trigger element 232 has an increased width 274 over some other embodiments where the trigger ends 236, 237 extend closer to the electrodes 226, 227.

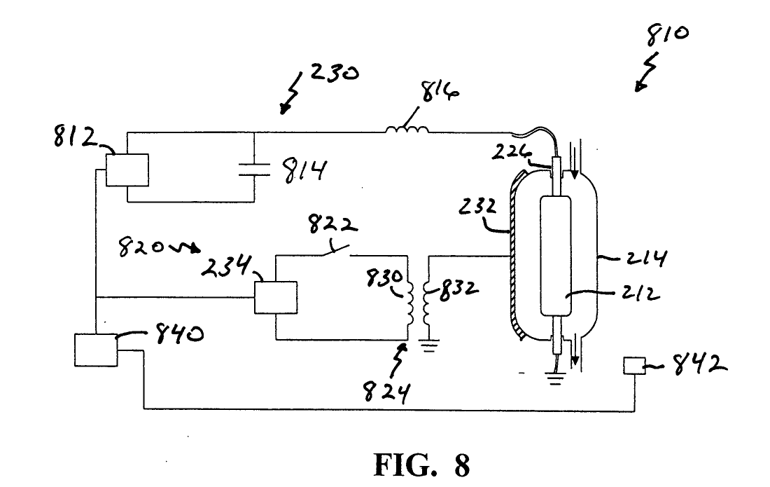

FIG. 8 depicts a simplified schematic diagram of the fluid treatment system 810 according to some embodiments. The fluid treatment system includes a flash lamp 212 enclosed within a chamber 214. The chamber circulates a fluid 224, such as water or other fluids, about the flash lamp to be treated by the illumination from the flash lamp. An excitation system 230 couples with the flash lamp to supply an excitation voltage to the flash lamp. The excitation system 230 includes a power source 812 that charges an excitation capacitance 814. The power source can be a DC power source, an AC power source with a rectifier and/or AC to DC conversion and other similar sources that charge the excitation capacitance 814. In some embodiments, the excitation system 230 includes a series energy storing inductance 816. The series inductance couples with the anode 226 of the flash lamp 212.

The fluid treatment system 810 further includes a pulse or triggering network 820. The trigger network includes a trigger source 234 coupled through a switch 822 to a transformer 824. The primary windings 830 couple with the trigger source 234 and the secondary winding 832 couples with a trigger element 232. The trigger source periodically supplies a trigger voltage through the switch 822 to the primary windings 830. The trigger pulse is transformed through the secondary winding to be applied to the trigger element 212.

In some embodiments, the fluid treatment system 810 further includes a controller 840. The controller couples with the charge source 812, the trigger source 234 and typically the switch 822. The controller can be configured to determine and/or adjust the voltages to be applied through one or both of the charge source and the trigger source. Similarly, the controller 840 can further control the flash rate and/or timing of the excitation voltage and/or pulse voltage by activating and deactivating the trigger source and/or opening and closing the switch 822.

In some embodiments, the controller further couples with one or more measurement devices 842 to measure the generated emission output from the flash lamp 212 and chamber 214. The measurement devices 842 provide feedback to the controller for additional control over the fluid treatment system 210. In some embodiments, the measurement devices are external to the chamber, and in some embodiments the measurement devices can be incorporated into the interior of the chamber.

The one or more measurement devices 842 can be one or more of several types of optical detectors or optical monitoring devices, such as photodetectors, photodiodes, fiber optic probes, calorimeters, joulemeters, photomultiplier tubes (PMTs), cameras, charged coupled device (CCD) arrays, and inputs to a spectrometer, such as a spectroradiometer. These measurement devices 842 can also be thermodetectors, such as thermocouples, thermopiles, calorimeters, and joulemeters. In one embodiment, one or more of measurement devices are photodetector devices that receive light emitted directly from the flash lamp 212 and chamber 214. Furthermore, in some embodiments, one or more of the measurement devices detect the ultraviolet (UV) portion of the light, while other measurement devices detect full spectrum light emitted from the light source. For example, in one embodiment, the measurement devices 842 comprise fiber optic probes that are coupled to a two-channel spectrometer, such that one channel is used to measure the UV content of the light treatment and the other channel is used to measure the visible spectrum of the light treatment.

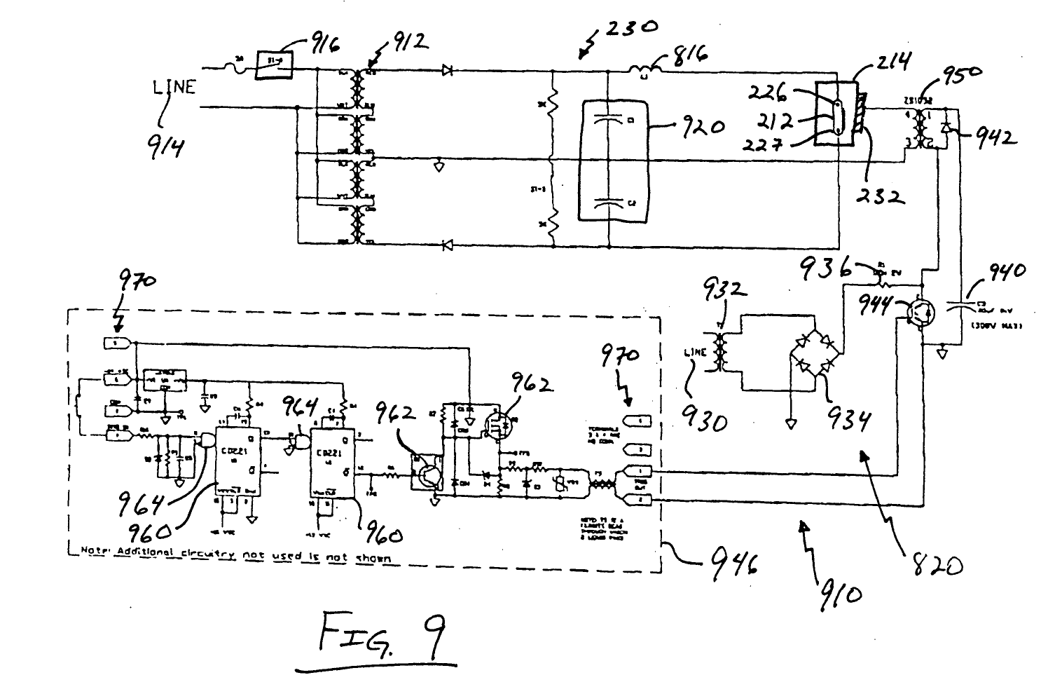

FIG. 9 depicts a simplified schematic diagram of a flash lamp assembly 910 according to some embodiments that can be incorporated into fluid treatment systems, such as fluid treatment system 810 shown in FIG. 8. The flash lamp assembly 910 includes a flash lamp 212 having two electrodes 226, 227. The flash lamp is further enclosed in a chamber 214. An excitation system 230 couples with the flash lamp 212 to supply an excitation voltage to the flash lamp.

The excitation system 230 includes a transformer 912 with the primary windings coupled with a line voltage or other power source 914. In some embodiments, a switch 916 is coupled between the transformer and the power source 914 to control the excitation of the flash lamp 212. The secondary windings of the transformer 912 couple across a capacitance 920 such that when power is supplied to the transformer, the capacitance 916 is charged. An energy storage series inductance 816 is coupled between the transformer and the anode 226 of the flash lamp 212 as well as between the capacitance 920 and the anode of the flash lamp.

The flash lamp assembly 910 additionally includes a pulse or triggering network 820. The trigger network includes a line or power source 930. In some embodiments the line source 930 is the same line or power source 914 coupled with the excitation circuit. The line source 930 couples with a source transformer 932. The transformer further couples across a rectifier 934.

A trigger capacitance 940 couples with the rectifier 934 through a resistance 936 and a diode 942. The trigger capacitance is charged through the rectifier 934 to desired voltage levels. A transistor 944 couples with the resistance 936 and across the trigger capacitance 940. A control circuit 956 couples with the transistor 944 to open and close the transistor such that the transistor operates as a switch for charging the trigger capacitance 940.

The trigger capacitance further couples with a trigger transformer 950. A diode 942 is coupled across the primary windings of the trigger transformer 940 to prevent reverse flow from the trigger capacitance. The transformer further couples with a trigger element 232 secured with the exterior of the chamber 214. Upon discharge from the trigger capacitance 940, the transformer supplies a trigger voltage to the trigger element 232 triggering the flash lamp 212.

The controller 946 can be implemented through any number of circuitry components including microchips 960, transistors 962, gates 964 and other circuitry. The controller includes a plurality of inputs and outputs 970. The inputs can be for power, feedback, measurements from measurement devices 842 (see FIG. 8) and other similar inputs that aid in controlling the triggering according to desired flash rates and/or treatment plans.

In some embodiments of the fluid treatment systems 510, 810, 910 that treat flowing fluid products, the light source 212 operates at a predefined flash rate as discussed above. The flash rate of the pulsed flash lamp 212 light source is important in meeting treatment objectives. For example, the rate of fluid flow through a treatment chamber affects the rate at which the pulsed flash lamp is discharged in order to meet a desired level of fluid treatment. Furthermore, the geometry of the treatment chamber or fluid flow path affects the velocity of the fluids through the chamber. In some embodiments the fluid flow is controlled through similar methods and systems fully described in U.S. patent Ser. No. 10/664,249, filed Sep. 16, 2003, entitled METHOD AND APPARATUS FOR CONTROLLING FLOW PROFILE TO MATCH LAMP FLUENCE PROFILE, incorporated herein by reference in its entirety.

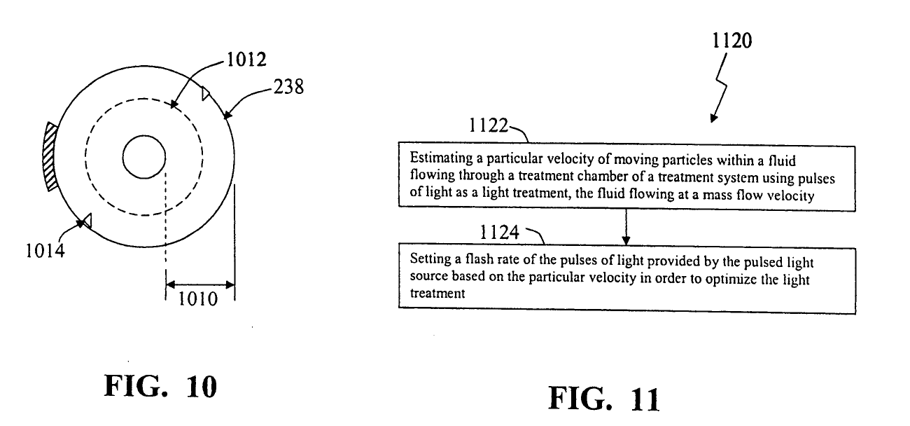

FIG. 10 depicts a simplified cross-sectional view along an axis labeled 280 in FIG. 6 of a flash lamp assembly 210 according to some embodiments of the present invention. By way of example, across the distance 1010 between the flash lamp 210 and the chamber wall 238, particles of the fluid flow at different velocities depending on the location across the distance 1010. Generally, the velocity of particles across the distance has a parabolic particle velocity profile. Typically fluid particles flowing along the wall or boundary 238 of the treatment chamber 214 flow slightly slower than particles flowing through the central portion 1012 of the distance 1010 between the flash lamp 210 and chamber wall 238. The centerline velocity is typically the peak particle velocity within the fluid flow. Additionally, it is noted that the particles near the flash lamp and chamber wall flow slower than, and the particles in the central region 1012 between the flash lamp and chamber wall flow faster than, the mass flow rate (or average flow rate) of the fluid entering the treatment chamber 214. Further, the chamber 214 can be configured with mixing or agitating members 1014 that cause the fluid to be circulated around the flash lamp 212 so that the fluid is varied over the distance 1010 between the flash lamp 212 and the chamber wall 238.

Disadvantageously, if the flash rate of the pulsed flash lamp 212 is set based upon a mass flow rate (average flow rate) of the fluid entering the chamber 214, some portions of the fluid or fluid particles have the potential to be under-treated since they will be flowing faster than the mass flow rate.

Additionally, the viscosity of the fluid product also affects the variances in fluid flows across the thickness of the treatment chamber. The mass flow rate of the fluid is another factor. For example, altering the velocity at which a fluid is flowed through the chamber 214 may affect the variances in fluid flow velocity within the fluid flow.

Accordingly, some preferred embodiments determine or estimate a particular fluid and/or particle flow velocity within a fluid flow through a chamber 214, and then set the flash rate based on the particular flow velocity, rather than based on the mass flow rate. In some embodiments, and depending on the degree to which the operator is concerned with under-treatment, the particular flow velocity may be that of the fastest fluid flow or particles, i.e., the peak velocity. Alternatively, the flash rate may be set based upon a particular particle flow rate that is a percentage of the peak particle flow velocity. For example, the flash rate may be based upon 80% of the peak particle flow velocity.

In some embodiments, the optical characteristics of the fluid product (e.g., absorption) and the distance 1010 between the flash lamp 212 and the chamber wall 238 are considered to select an appropriate particle velocity along a particle velocity profile.

FIG. 11 depicts a flowchart of a process 1120 for use in setting the flash rate of a flash lamp in a fluid treatment system, such as the fluid treatment system 510 of FIG. 5. In step 1122, a particular velocity of moving particles within a fluid flowing through a treatment chamber of a treatment system is estimated using pulses of light as a light treatment, where the fluid is flowing at a mass flow velocity. In some embodiments, the treatment chamber and the fluid are transmissive to at least 1% of light having at least one wavelength within a range of 170 to 2600 nm. The light treatment may be any monochromatic or polychromatic pulsed light treatment, such as those described herein. The particular velocity may be the fastest particle velocity (peak particle velocity), the slowest particle velocity, or other particular particle flow velocity. In some embodiments, the particular particle flow velocity is a ratio of a centerline velocity (typically the peak particle velocity) to the mass flow rate (average flow rate).

Once the particular particle velocity is estimated, step 1124 is entered where a flash rate of the pulses of light provided by the pulsed flash lamp is set based on the particular velocity in order to optimize the light treatment. In some embodiments, the flash rate is set based a ratio centerline to mass flow rate.

In order to determine the particular particle flow velocity, in one embodiment, a design of experiment (DOE) tool is used to develop an equation for the particular particle flow velocity as a function of several input variables. In one embodiment, the design of experiment tool generates a single equation to model the particle velocity profile given three input variables: fluid viscosity (i.e., a fluid characteristic), distance 1010 between the flash lamp and the chamber wall (i.e., a flow geometry), and a mass flow rate of the fluid through the treatment chamber. It is noted that other fluid characteristics and flow geometries may be used to model different equations. In one variation, the single equation generated for the particle velocity profile is expressed in terms of a ratio of the centerline (i.e., peak velocity) to average velocity. Thus, the velocity vectors are normalized to the average velocity. This DOE can be implemented similar to the DOE described in U.S. patent application Ser. No. 10/150,345, of Brown et al., entitled LIGHT TREATMENT CONTROL IN A FLUID TREATMENT SYSTEM USING LIGHT FOR THE TREATMENT OF FLUID PRODUCTS, filed May 17, 2002, Docket No. 72722.

Additionally and/or alternatively, the flash rate may be set based on one or more of the fluid viscosity, the flow geometry or the mass flow rate may be adjusted. For example, rather than adjust the flash rate, the mass flow rate is adjusted such that the particular velocity is increased or decreased to better match the flash rate. In another example, the viscosity of the fluid product is adjusted, e.g., by metering in more or less of a buffer fluid. Furthermore, the flash rate and one or more of the fluid viscosity, the treatment chamber geometry or the mass flow rate may be adjusted together.

It is noted that a system controller may be adapted to solve the equation through DOE software to determine what adjustments are needed and then make the appropriate adjustments to the flash rate, fluid viscosity, fluid geometry and/or mass flow rate. For example, the controller will send the appropriate control signals to adjust the flash rate, the flow rate and/or fluid viscosity.

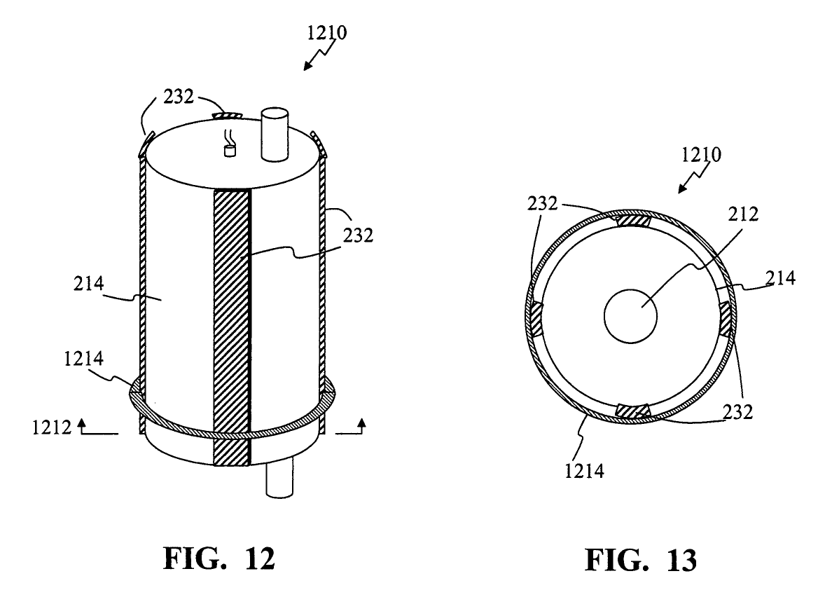

FIG. 12 is a simplified cross-sectional view of a flash lamp assembly 1210 according to some present embodiments. FIG. 13 depicts a simplified cross-sectional view of the flash lamp assembly 1210 of FIG. 12 viewed from an axis 1212 of FIG. 12. Referring to FIGS. 12 and 13, the assembly includes four trigger elements 232 positioned about the chamber 214. It is noted that substantially any number of trigger elements can be incorporated on the exterior of the chamber or enclosure. A conductor 1214 can extend around to each trigger element and couple with a trigger network (e.g., trigger network 620 of FIG. 5). Alternatively, a trigger network can couple with each trigger element.

Each of trigger element can be positioned with ends proximate the flash lamp electrodes 226, 227. The spacing of the trigger elements about the chamber 214 depends on the size of the chamber, the size of the trigger elements, the fluid to be treated, the desired treatment process and other similar factors. In some embodiments, the trigger elements are distributed circumferentially and equally spaced 90 degrees around the chamber. In some alternative embodiments, the triggering elements can be one or more bands or rings extend circumferentially around the chamber.

While these embodiments have been described by means of specific embodiments and applications thereof, numerous modifications and variations could be made thereto by those skilled in the art without departing from the scope of the invention set forth in the claims.

1. A flash lamp assembly, comprising:
a flash lamp comprising a first electrode and a second electrode;
a chamber that surrounds the flash lamp, wherein the first and second electrodes extend through and out of the chamber; and
a trigger element positioned over a portion of an exterior of the chamber.

2. The flash lamp assembly of claim 1, wherein the trigger element has a first end and a second end, and the trigger element is positioned adjacent the chamber such that the first end of the trigger element is proximate the first electrode and the second end of the trigger element is proximate the second electrode.

3. The flash lamp assembly of claim 1, wherein the trigger element extends generally parallel along a length of the chamber.

4. The flash lamp assembly of claim 3, wherein the trigger element comprises multiple substantially parallel trigger elements distributed circumferentially around the chamber.

5. The flash lamp assembly of claim 1, wherein the trigger element comprises multiple parallel elements wrapped circumferentially around the chamber, and a conductor coupled with the parallel elements.

6. The flash lamp assembly of claim 1, further comprising:
a triggering network coupled with the trigger element to apply a trigger voltage to the trigger element; and
an excitation system coupled with at least the first electrode to excite the flash lamp.

7. The flash lamp assembly of claim 1, wherein the chamber further comprises an inlet and an outlet, wherein a fluid is passed in the inlet and out the outlet to pass about the flash lamp.

8. The flash lamp assembly of claim 7, wherein the fluid does not contact the trigger element.

9. A fluid treatment system, comprising:
a chamber;
a flash lamp having a first electrode and a second electrode, wherein the flash lamp is enclosed within the chamber; and
a trigger element positioned adjacent an exterior of the chamber and extending along at least a portion of a length of the chamber;
wherein the chamber further comprising an inlet and an outlet, wherein a fluid to be treated is pushed into the chamber through the inlet and out of the chamber through the outlet to pass about the flash lamp to be treated.

10. The system of claim 9, wherein the trigger element comprises a first end and a second end, where the trigger element is positioned such that the first end is proximate the first electrode and the second end is proximate the second electrode.

11. The system of claim 10, further comprising:
a fluid reservoir containing the fluid coupled with the chamber; and
a fluid movement system coupled with the fluid reservoir, wherein the fluid movement system pushes the fluid through the chamber and about the flash lamp.

12. The system of claim 9, wherein a width of the trigger element is proportional to a trigger voltage.

13. The system of claim 9, wherein the first end of the trigger element is positioned a predefined distance from the first electrode wherein the predefined distance is proportional to a width of the trigger element.

14. The system of claim 9, further comprising:
a triggering network coupled with the trigger element to apply a trigger voltage to the trigger element; and
an excitation system coupled with at least the first electrode to excite the flash lamp.

15. A method of treating a fluid, comprising:
flowing a fluid to be treated into a chamber such that the fluid circulates about a flash lamp that is housed within the chamber;
exciting the flash lamp; and
triggering the flash lamp through a trigger that is external to the chamber such that the flash lamp flashes treating the fluid.

16. The method of claim 15, wherein the flowing the fluid further comprises maintaining a portion of the fluid within the chamber for a predefined period of time about the flash lamp; and
the triggering further comprises triggering the trigger a plurality of times such that the flash lamp flashed a predefined number of times during the predefined period of time.

17. A method for triggering a flash lamp system, the method comprising:
applying a trigger pulse to a trigger electrode structure located external to an enclosure, where a flash lamp is located substantially inside the enclosure; and
pulsing the flash lamp following the applying of the trigger pulse.

18. The method of claim 17, further comprising:
pushing a fluid through the enclosure such that the fluid passes about the flash lamp as the trigger pulse is applied such that the fluid does not contact the trigger electrode.

19. The method of claim 17, wherein the fluid pushed into the enclosure is a gas.
